(19) United States
(12) Patent Application Publication
(10) Pub. No.: US 2015/0068617 A1
(43) Pub. Date: Mar. 12, 2015

(54) VALVE AND FUEL TANK STRUCTURE

(71) Applicant: TOYOTA JIDOSHA KABUSHIKI KAISHA, Toyota-shi (JP)

(72) Inventors: Shinji SHIMOKAWA, Seto-shi (JP); Masahide KOBAYASHI, Toyota-shi (JP); Yoshitaka NOBUSADA, Toyota-shi (JP)

(21) Appl. No.: 14/470,094

(22) Filed: Aug. 27, 2014

(30) Foreign Application Priority Data
Sep. 12, 2013 (JP) 2013-189476

(51) Int. Cl. B60K 15/035

(52) U.S. Cl. CPC B60K 15/03519; B60K 2015/03289
USPC 137/409

(57) ABSTRACT

A valve includes: a float that is provided within a fuel tank and that, by floating in fuel, blocks a communication hole that communicates with an engine, a housing that accommodates the float within the fuel tank such that the float can move vertically, and into and from which fuel, that is within the fuel tank, enters and exits, and a dam member that is provided at the float, and that locally narrows a gap between the float and the housing.

### CROSS-REFERENCE TO RELATED APPLICATION

This application is based upon and claims the benefit of priority of the prior Japanese Patent Application No. 2013-189476, filed on Sep. 12, 2013, the entire contents of which are incorporated herein by reference.

### FIELD

The embodiments discussed herein are related to a valve and a fuel tank structure.

### BACKGROUND

There are structures in which, when fuel is supplied to a fuel tank, a float rises and blocks a communication path from the fuel tank to the engine (see, for example, Japanese Laid-Open Patent Publication No. 09-264220).

In a structure in which a communication hole for communication with the engine is blocked by a float that rises within a fuel tank in this way, when pressure fluctuations from the engine are applied from the communication hole to the float, there is the concern that the float will move vertically and some sound may be generated.

### SUMMARY

In a first aspect, a valve has: a float that is provided within a fuel tank and that, by floating in fuel, blocks a communication hole that communicates with an engine; a housing that accommodates the float within the fuel tank such that the float can move vertically, and into and from which fuel, that is within the fuel tank, enters and exits; and a dam member that is provided at the float, and that locally narrows a gap between the float and the housing.

In this valve, the float floats (rises) within the housing due to a rise in the liquid level within the fuel tank. Further, due to the communication hole that communicates with the engine being blocked by the float that has risen, flowing-out of vapor from the fuel tank is suppressed.

The dam member is provided at the float. Due to this dam member, the gap between the float and the housing is narrowed locally as compared with a structure that does not have this dam member. Accordingly, even if pressure from the engine is applied from the communication hole to the float, resistance is imparted by the dam member to vertical movement of the float. Due thereto, vertical movement of the float can be suppressed.

In a second aspect, in the first aspect, the valve further has: a fuel inflow port that is formed in the housing and through which fuel, that flows into the housing, passes; and a resistance member that, at least in a state in which the float blocks the communication hole, applies movement resistance to fuel that passes through the fuel inflow port.

Because the fuel inflow port is formed at the housing, the fuel that is within the fuel tank flows into the housing from the fuel inflow port. When the float floats and rises in the fuel that has flowed into the housing, the float blocks the communication hole.

This valve has the resistance member. At least in the state in which the float blocks the communication hole, the resistance member imparts movement resistance to the fuel that passes through the fuel inflow port. Accordingly, when the fuel attempts to pass through the fuel inflow port accompanying the vertical movement of the float, the resistance that is applied to this passage of fuel becomes large. Therefore, resistance to the vertical movement of the float also becomes large.

In a third aspect, in the second aspect, the resistance member includes a mesh member that is provided at the fuel inflow port.

By the simple structure of providing the mesh member at the fuel inflow port, the resistance member is structured and resistance can be imparted to the fuel that passes through the fuel inflow port.

In a fourth aspect, in the second aspect, the resistance member includes a cover member that moves vertically together with the float and that, by rising, blocks at least a portion of the fuel inflow port.

When the float rises, the cover member blocks at least a portion of the fuel inflow port. Therefore, resistance can be imparted to the fuel that passes through the fuel inflow port.

Further, at times when the float has not risen, the cover member opens the fuel inflow port greatly, and a structure in which resistance to the fuel, that passes through the fuel inflow port, is made to be low can be realized.

In a fifth aspect, in the fourth aspect, the cover member is molded integrally with the float.

By molding the cover member integrally with the float, the number of parts is lower than that of a structure in which the cover member is molded as a separate body.

In a sixth aspect, a fuel tank structure has: a fuel tank that accommodates fuel; and the valve of any one of the first aspect through the fifth aspect that is provided within the fuel tank and at a communication pipe that communicates the fuel tank and an engine.

In this fuel tank structure, when fuel is supplied into the fuel tank and the liquid level within the housing becomes higher than the buoyancy point of the float, the float floats in the fuel and rises. The fuel tank and the engine are communicated by the communication pipe.

Further, because the fuel tank structure has the valve of any one of the first aspect through the fifth aspect, even if pressure from the engine is applied to the float from the communication hole, vertical movement of the float can be suppressed.

### BRIEF DESCRIPTION OF DRAWINGS

FIG. 1 is a schematic structural drawing showing a fuel tank structure of a first embodiment of the present invention.

FIG. 2 is a vertical sectional view showing a valve of the first embodiment of the present invention.

FIG. 3 is a cross-sectional view along line 3-3 of FIG. 2, showing the valve of the first embodiment of the present invention.

FIG. 4 is a vertical sectional view showing the valve of the first embodiment of the present invention.

FIG. 5 is a vertical sectional view showing a valve of a second embodiment of the present invention.

FIG. 6 is a perspective view showing, partially and in an enlarged manner, the valve of the second embodiment of the present invention.

FIG. 7 is a vertical sectional view showing the valve of the second embodiment of the present invention.

FIG. 8 is a vertical sectional view showing a valve of a third embodiment of the present invention.

FIG. 9 is a schematic vertical sectional view showing a modified example of the valve of the present invention.

FIG. 10 is a schematic vertical sectional view showing a modified example of the valve of the present invention.

### DESCRIPTION OF EMBODIMENTS

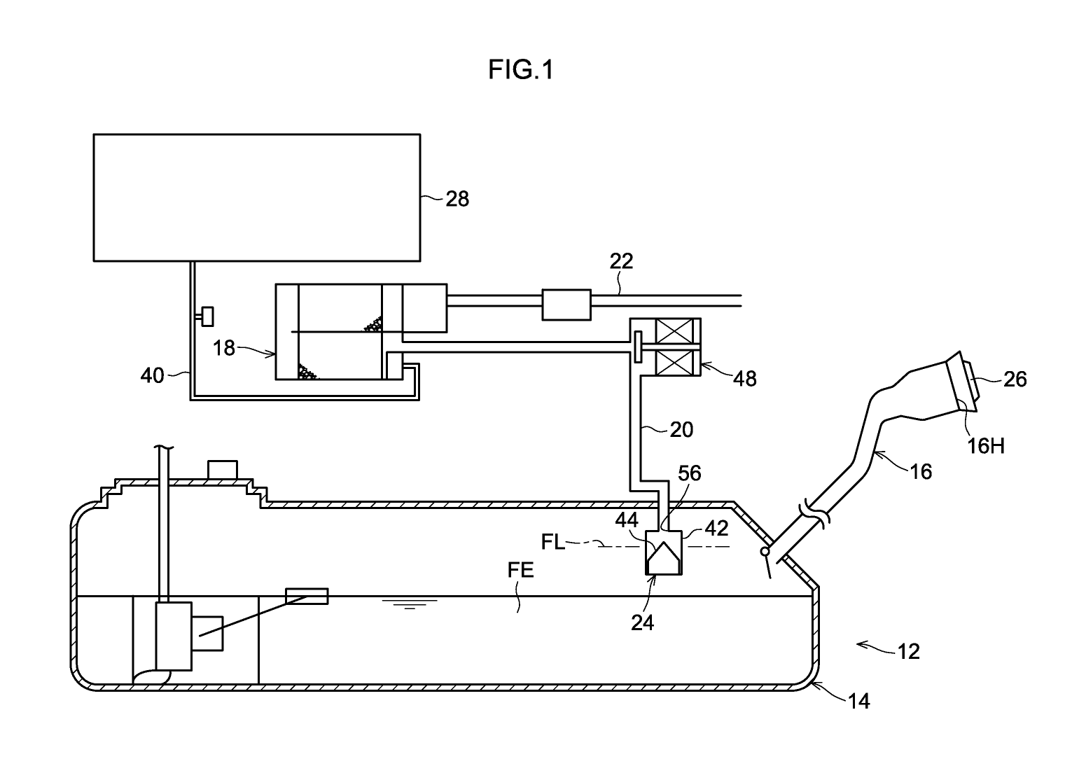

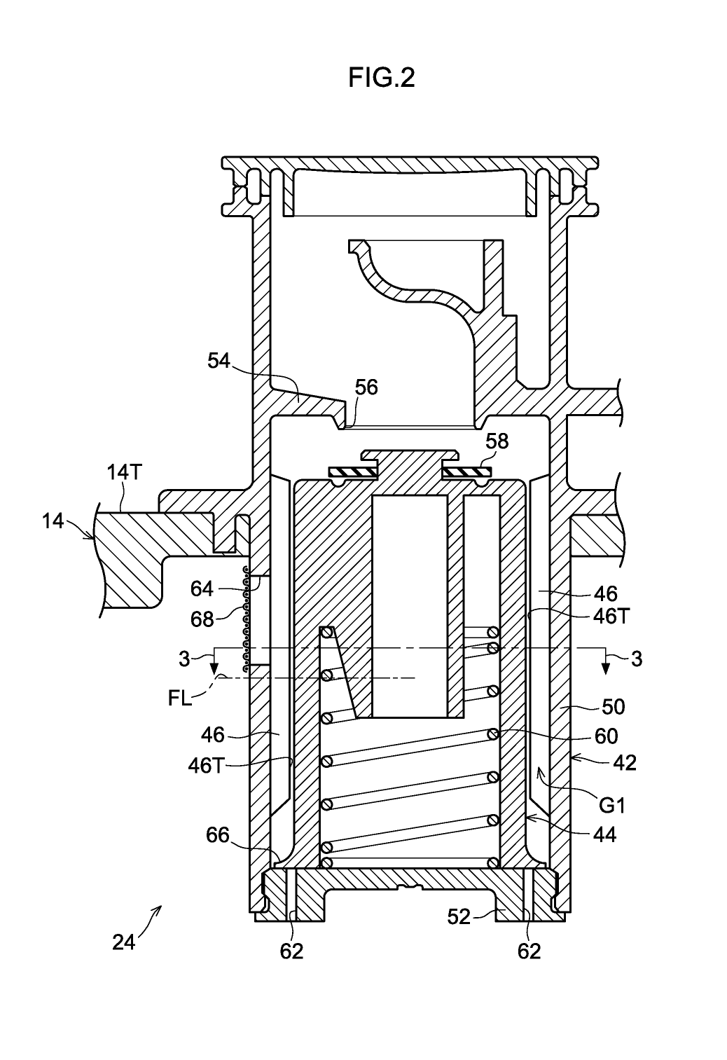

A fuel tank structure 12 of a first embodiment of the present invention is shown in FIG. 1. Further, an ORVR (Onboard Refueling Vapor Recovery) valve 24, that structures the fuel tank structure 12, and the vicinity thereof are shown in a cross-sectional view in FIG. 2. The ORVR valve 24 is an example of the “valve” relating to the present application.

The fuel tank structure 12 has a fuel tank 14 that can accommodate fuel at the interior thereof. The lower end portion of an inlet pipe 16 is connected to the upper portion of the fuel tank. The opening portion at the upper end of the inlet pipe 16 is a fueling port 16H. A fueling gun is inserted in the fueling port 16H, and fueling of the fuel tank 14 can be carried out. The fueling port 16H of the inlet pipe 16 is usually opened and closed by a fuel cap 26, and, at times of fueling, the fuel cap 26 is removed by the fueling operator or the like.

A canister 18 is provided at the exterior of the fuel tank 14. An adsorbent such as active carbon or the like is accommodated at the interior of the canister 18. The vapor layer at the interior of the fuel tank 14 and the canister 18 are connected by a communication pipe 20. A sealing valve 48 is provided midway along the communication pipe 20. The sealing valve 48 is an electromagnetic valve in the present embodiment, and the opening and closing thereof are controlled by a control device.

In the state in which the sealing valve 48 is open, the vapor within the fuel tank 14 can move through the communication pipe 20 to the canister 18, but, in the state in which the sealing valve 48 is closed, this movement of vapor is not possible. The evaporated fuel within the vapor that has moved to the canister 18 is adsorbed by the adsorbent of the canister 18, and the vapor (the atmosphere component) other than the evaporated fuel is discharged into the atmosphere from an atmosphere communication pipe 22.

The canister 18 and an engine 28 are connected by a purge pipe 40. Due to negative pressure of the engine 28 being applied to the canister 18 in the state in which the sealing valve 48 is closed, atmospheric air is introduced-in from the atmosphere communication pipe 22, and the evaporated fuel that has been adsorbed by the adsorbent can be released (purged). The evaporated fuel that is released is sent to and combusted at the engine 28.

The ORVR valve 24 is provided at the lower end of the communication pipe 20 to as to be positioned at the upper portion of the interior of the fuel tank 14. The ORVR valve 24 is a so-called float valve and has, within a valve housing 42, a float 44 that floats in fuel FE.

As shown in detail in FIG. 2, the valve housing 42 of the ORVR valve 24 has a housing main body 50 and a housing bottom plate 52. The housing main body 50 is substantially cylindrical tube shaped, and the bottom portion thereof is open. The housing bottom plate 52 is installed at the bottom portion of this housing main body 50. The upper portion of the housing main body 50 is positioned further upward than a ceiling plate 14T of the fuel tank 14, and is a connection portion to which the communication pipe 20 (see FIG. 1) is connected.

A partitioning wall 54, that partitions the interior of the housing main body 50 vertically, is formed at the housing main body 50. A communication hole 56, that makes the inner diameter of the housing main body 50 small locally, is formed in the partitioning wall 54. Further, the float 44, that is substantially solid cylindrical or substantially cylindrical tube shaped, is accommodated between the partitioning wall 54 and the housing bottom plate 52.

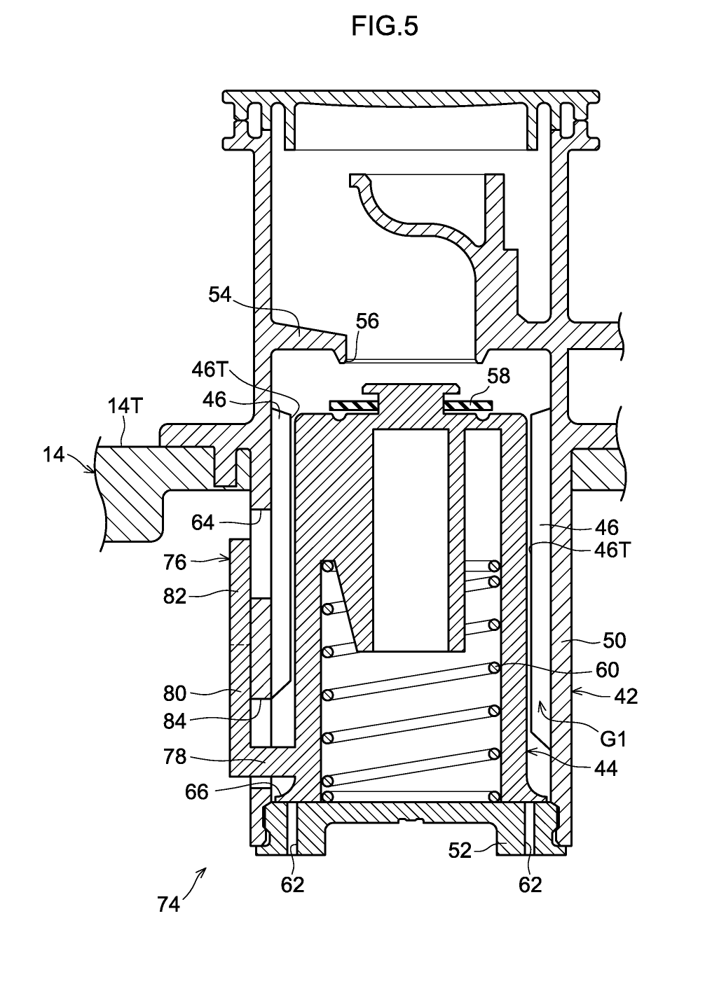

A valve seat 58 that is annular is installed at the upper portion of the float 44. The closed-valve state shown in FIG. 5 arises due to the float 44 approaching the partitioning wall 54 (rising in the example of FIG. 2) and the valve seat 58 contacting (tightly fitting to) the partitioning wall 54 at the periphery of the communication hole 56. In the closed-valve state, the communication hole 56 is blocked, and movement of vapor from the interior of the fuel tank 14 to the canister 18 is impeded. In contrast, the state in which the valve seat 58 has moved away from the partitioning wall 54 is the open-valve state that is shown in FIG. 2. In the open-valve state, vapor can move through the communication hole 56.

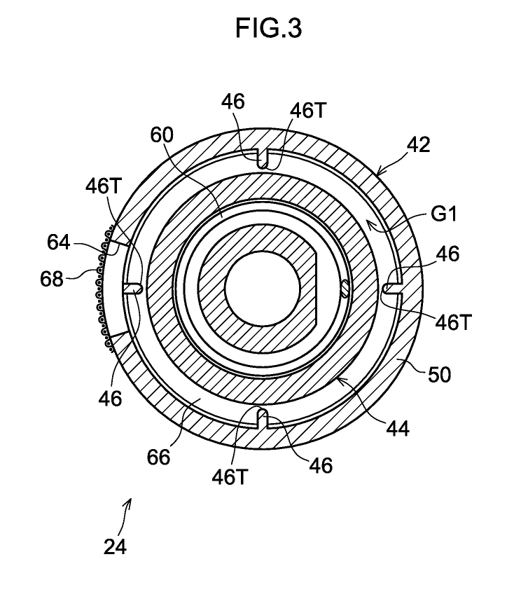

Plural ribs 46 are formed at the inner peripheral surface of the housing main body 50, further downward than the partitioning wall 54 at the valve housing 42. The respective ribs 46 extend in the vertical direction. As shown in FIG. 3 as well, the plural ribs 46 are disposed at a predetermined interval in the peripheral direction of the valve housing 42. Distal ends 46T of the ribs 46 face the outer peripheral surface of the float 44 with a slight gap therebetween. Due thereto, the ribs 46 suppress lateral shifting and rattling at the time when the float 44 moves vertically, and guide the vertical movement of the float 44.

A spring 60 is disposed between the float 44 and the housing bottom plate 52. The spring 60 applies spring force in the valve-closing direction (upward in the example of FIG. 2) to the float 44.

As shown in FIG. 2, in a state in which fuel does not exist within the valve housing 42, spring force in the valve-closing direction (upward) is applied from the spring 60 to the float 44. However, because the gravitational force of the float 44 is greater, the float 44 is in the open-valve state. Further, even if fuel does exist within the valve housing 42, in a state in which the liquid level is lower than a float buoyancy liquid level FL (details of which are described later), the resultant force of the spring force of the spring 60 and the buoyancy from the fuel is lower than the gravitational force applied to the float 44. Therefore, the float 44 does not move in the valve-closing direction, and is in the open-valve state.

In contrast, when the liquid level within the valve housing 42 becomes equal to or higher than the float buoyancy liquid level FL, the resultant force of the spring force of the spring 60 and the buoyancy from the fuel becomes greater than the gravitational force that is applied to the float 44, and the float 44 enters into the closed-valve state.

Note that, when the ORVR valve 24 is turned upside-down, the gravitational force applied to the float 44 and the spring force from the spring 60 are both in the valve-closing direction, and become greater than the buoyancy from the fuel that is applied to the float 44. Therefore, the float 44 enters into the closed-valve state, and flowing-out of fuel from the fuel tank 14 is suppressed.

One or plural flow-out holes 62 are formed in the housing bottom plate 52. The fuel within the valve housing 42 passes through the flow-out holes 62 and flows-out to the exterior of the valve housing 42 (into the interior of the fuel tank 14).

A fuel inflow port 64 is formed in the peripheral wall of the housing main body 50. Fuel within the fuel tank 14 passes through the fuel inflow port 64 and enters into and exits from the interior of the valve housing 42.

In the present embodiment, the lower end of the fuel inflow port 64 is formed at a position higher than the float buoyancy liquid level FL (however, is formed at a height that is positioned within the fuel tank 14 and lower than the partitioning wall 54). Accordingly, in a case in which the fuel FE is at a liquid level that is equal to or higher than the float buoyancy liquid level FL within the valve housing 42, even if the fuel FE flows-out from the fuel inflow port 64, the liquid level becoming lower than the float buoyancy liquid level FL is suppressed. However, in a case in which the fuel FE is at a liquid level that is beneath the float buoyancy liquid level FL, the fuel passes through the flow-out holes 62 and flows-out from the valve housing 42.

In contrast, the opening surface area of the flow-out holes 62 in the present embodiment is made to be small so that the float 44 will not fall in a short period of time at the time of fueling. Due thereto, a period of time in which fuel exists within the valve housing 42 can be sufficiently ensured. Further, in a state in which the liquid level within the fuel tank 14 is at a position that is lower than the flow-out holes 62 for example, fuel within the valve housing 42 gradually flows-out from the flow-out holes 62 into the fuel tank 14.

As shown in detail in FIG. 2 through FIG. 4, a dam member 66 extends out toward the radial direction outer side from the outer periphery of the float 44. The dam member 66 locally narrows a gap G1 between the float 44 and the valve housing 42. In other words, when seen along the direction of vertical movement of the float 44, the cross-sectional area of the float 44 is locally large as compared with a structure that does not have the dam member 66. Further, in a case in which the float 44 attempts to move vertically in the state in which fuel exists at the periphery of the dam member 66, not only the float 44, but also the dam member 66 hits the fuel. Because the region of passage of the fuel at the time when the float 44 attempts to move vertically is narrow, resistance is applied to the movement of fuel at this region of passage. Namely, in the present embodiment, resistance to vertical movement of the float 44 is large as compared with a structure that does not have the dam member 66.

There may be a structure in which the dam member 66 is formed as a body separate from the float 44 and is mounted to the float 44. However, in the present embodiment, the dam member 66 is molded integrally with the float 44, and an increase in the number of parts is suppressed.

Further, in the present embodiment, the dam member 66 is made into a shape that is continuous in the peripheral direction of the float 44, but the dam member 66 may be a shape that is discontinuous in the peripheral direction of the float 44.

A mesh member 68 is attached to the housing main body 50 so as to cover the fuel inflow port 64. In the present embodiment, the mesh member 68 is structured by a fabric-like member such as a woven fabric or a non-woven fabric or the like, and covers the entirety of the fuel inflow port 64 from the outer side of the housing main body 50. When fuel moves through the fuel inflow port 64, the fuel passes through the minute holes of the mesh member 68. Therefore, the resistance to movement of the fuel is large as compared with a structure that does not have the mesh member 68. The mesh member 68 is an example of the resistance member.

Operation of the fuel tank structure 12 of the present embodiment is described next.

In the state before fuel is supplied to the fuel tank 14, fuel does not exist within the valve housing 42 of the ORVR valve 24, and the float 44 is in the open-valve state as shown in FIG. 2. Because vapor within the fuel tank 14 moves from the communication pipe 20 to the canister 18, fuel can be supplied to the fuel tank 14 continuously.

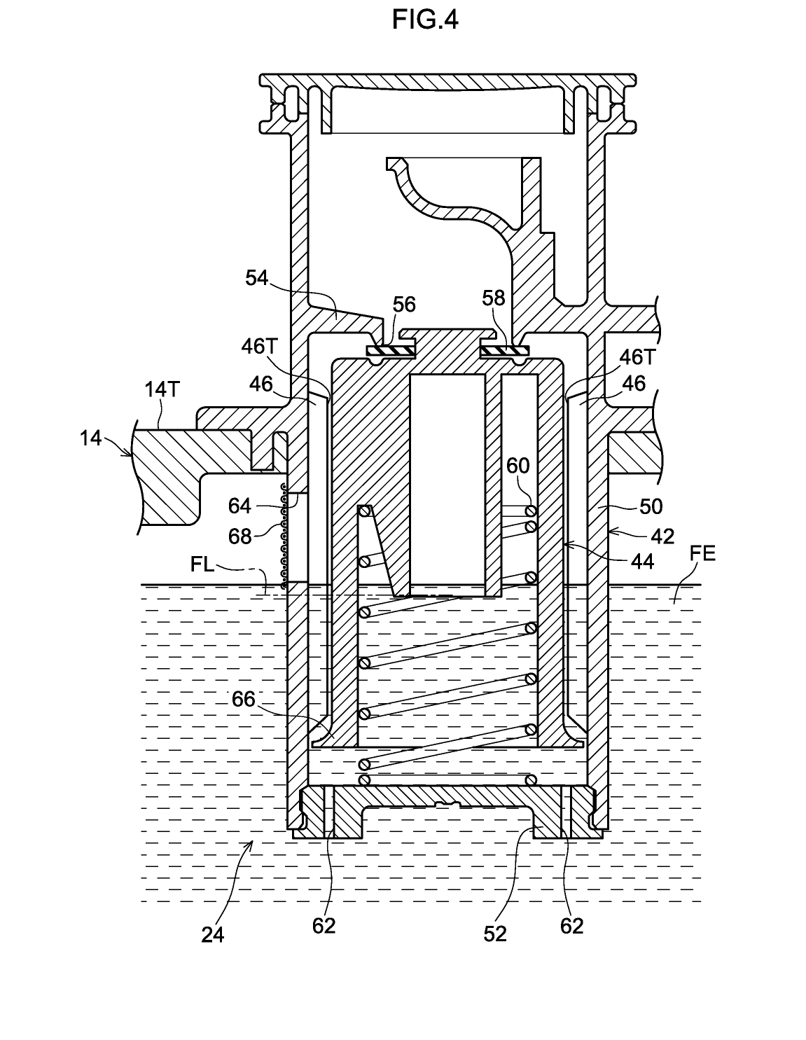

When fuel is supplied into the fuel tank 14 and the liquid level of the fuel that has flowed into the valve housing 42 becomes equal to or higher than the float buoyancy liquid level FL, the float 44 enters into the closed-valve state as shown in FIG. 4. The communication hole 56 is blocked, and vapor within the fuel tank 14 no longer flows from the communication pipe 20 to the canister 18. Therefore, the fuel that is supplied rises within the inlet pipe 16 and reaches the fueling gun. Then, the auto-stop mechanism of the fueling gun activates, and fueling of the fuel tank 14 is stopped.

When the sealing valve 48 opens in the state in which fuel is not being supplied to the fuel tank 14, pressure of the engine 28 passes through the purge pipe 40 and is applied to the canister 18. For example, negative pressure from the engine 28 acts on the canister 18, and the canister 18 can be purged.

Some of the pressure (the negative pressure and the positive pressure) that is applied from the engine 28 to the canister 18 is applied, through the communication pipe 20, to the ORVR valve 24. In particular, there are cases in which fluctuations in this pressure act on the float 44 as force that causes vertical movement (vibration).

At the ORVR valve 24 of the present embodiment, the dam member 66 is formed at the float 44, and the gap G1 between the float 44 and the valve housing 42 is narrowed locally. When the float 44 moves vertically, the resistance that is applied to the vertical movement of the float 44 is large as compared with a structure that does not have the dam member 66. Due thereto, vertical movement of the float 44 can be suppressed. In particular, vibration of the float 44 in cases in which pulsation of the pressure from the engine 28 arises (in cases in which negative pressure and positive pressure are applied repeatedly) can be suppressed.

Furthermore, at the ORVR valve 24 of the first embodiment, the mesh member 68 is attached to the fuel inflow port 64. When fuel moves through the fuel inflow port 64, large movement resistance is applied thereto as compared with a structure that does not have the mesh member 68. Because entering and exiting of the fuel, that is within the valve housing 42, through the fuel inflow port 64 is suppressed, the fuel that is within the valve housing 42 can be used effectively as resistance to vertical movement of the float 44. Namely, fuel that is within the valve housing 42 is made to work as a damper on the vertical movement of the float 44. Therefore, vertical movement of the float 44 can be suppressed more effectively.

Further, by suppressing vertical movement of the float 44, even in cases in which the float 44 is in a vicinity of the blocking position for example, the occurrence of abnormal sound that is due to vertical movement of the float 44 also can be suppressed.

Further, in the present embodiment, the fuel inflow port 64 is positioned further upward than the float buoyancy liquid level FL, and in addition, the opening cross-sectional areas of the flow-out holes 62 are made to be small so that the period of time over which fuel exists within the valve housing 42 can be ensured sufficiently. Accordingly, fuel flowing-out to beneath the float buoyancy liquid level FL within the valve housing 42 can be suppressed as compared with a structure in which the fuel inflow port 64 is positioned further downward than the float buoyancy liquid level FL or a structure in which the flow-out holes 62 are large.

Further, it is easy to maintain the state in which fuel, that is necessary to maintain the state in which the float 44 is floating in the fuel, exists within the valve housing 42, and the effect of suppressing vertical movement of the float 44 is strong.

A second embodiment is described next. An ORVR valve 74 of the second embodiment is shown in FIG. 5. In the second embodiment, structural elements, members and the like that are the same as those of the first embodiment are denoted by the same reference numerals, and detailed description thereof is omitted. Further, in the second embodiment, the overall structure of the fuel tank structure is similar to that of the first embodiment, and therefore illustration thereof is omitted.

The ORVR valve 74 of the second embodiment has, as an example of the resistance member, a cover member 76 instead of the mesh member 68 of the first embodiment.

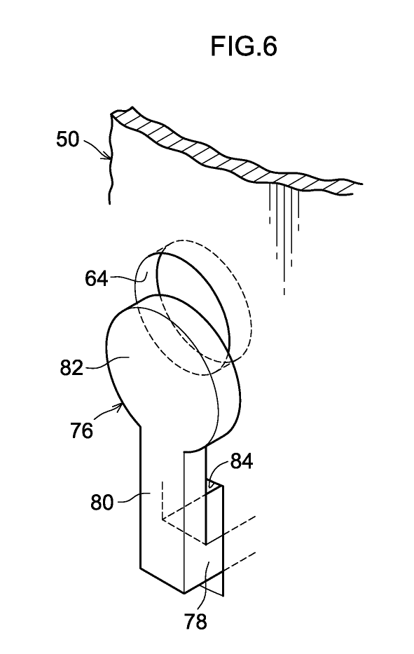

As shown in detail in FIG. 6 as well, the cover member 76 has a laterally extending portion 78, an upwardly extending portion 80, and a cover main body portion 82. The laterally extending portion 78 extends from the float 44 toward the radial direction outer side. The upwardly extending portion 80 extends upward from the distal end of the laterally extending portion 78. The cover main body portion 82 is substantially disc-shaped, and is provided at the distal end (the upper end) of the upwardly extending portion 80.

A through-hole 84 is formed in the housing main body 50. The laterally extending portion 78 passes through the through-hole 84. In the peripheral direction of the housing main body 50, the gaps between the through-hole 84 and the laterally extending portion 78 are set to be small. Due thereto, when the float 44 rotates in the peripheral direction, the laterally extending portion 78 contacts the inner surface of the through-hole 84, and acts as a rotation stopper that limits rotation of the float 44.

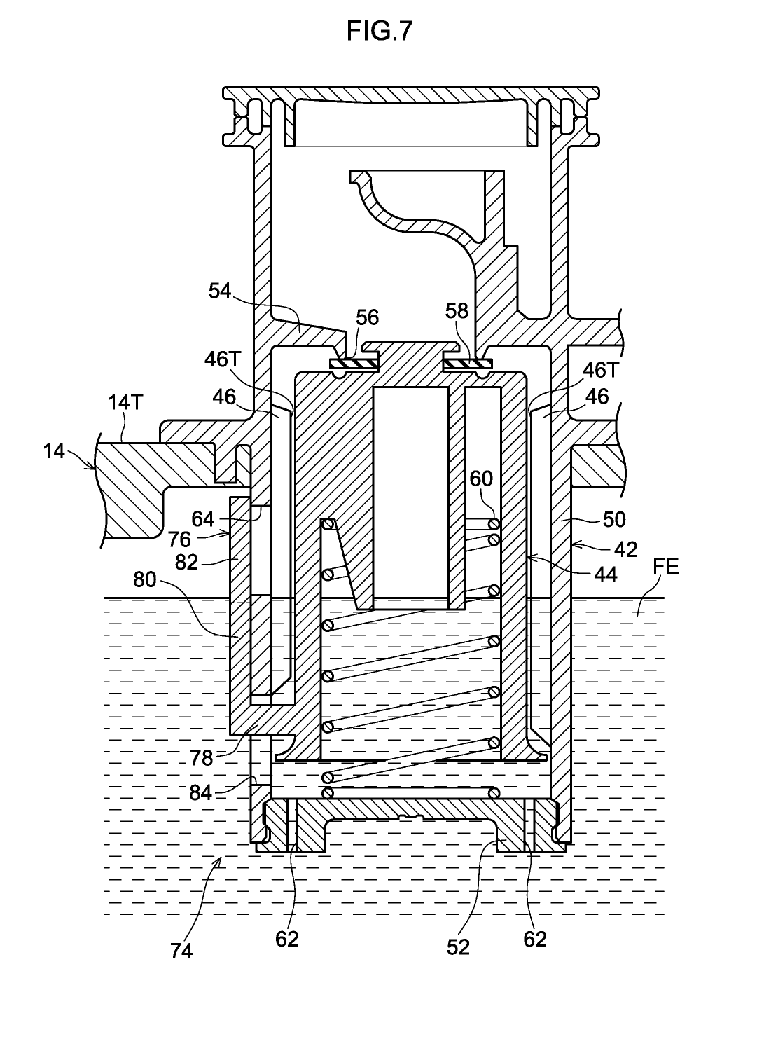

In contrast, the height of the through-hole 84 is made to be larger than the height of the laterally extending portion 78. Due thereto, vertical movement of the cover member 76, that accompanies vertical movement of the float 44, is permitted. Further, when the float 44 is in the opening state, as shown in FIG. 5, the cover main body portion 82 opens a portion of the fuel inflow port 64. In contrast, the shapes and the positions of the cover member 76 and the through-hole 84 are set such that, when the float 44 is in the blocking state, as shown in FIG. 7, the cover main body portion 82 covers the fuel inflow port 64 from the outer side.

Also in the ORVR valve 74 of the second embodiment that has such a structure, in a case in which some of the pressure of the engine 28 acts on the ORVR valve 74, the resistance to vertical movement of the float 44 increases due to the dam member 66. Further, vertical movement of the float 44 is suppressed.

In the ORVR valve 74 of the second embodiment, when the float 44 is in the blocking state, the cover member 76 covers the fuel inflow port 64. Therefore, large movement resistance is applied to movement of the fuel as compared with a structure in which the fuel inflow port 64 is not covered. Because entering and exiting of the fuel, that is within the valve housing 42, through the fuel inflow port 64 is suppressed, the fuel that is within the valve housing 42 can be effectively used as resistance to vertical movement of the float 44, and vertical movement of the float 44 can be suppressed. Note that, in the second embodiment, when the float 44 is in the opening state, a portion of the fuel inflow port 64 is not covered by the cover member 76, and therefore, there is little effect on the entering and exiting of fuel into and from the valve housing 42.

Furthermore, in the same way as in the ORVR valve 24 of the first embodiment, the fuel inflow port 64 is positioned further upward than the float buoyancy liquid level FL, and the opening cross-sectional areas of the flow-out holes 62 are made to be small. Therefore, it is easy to maintain the state in which fuel exists within the valve housing 42, and the effect of suppressing vertical movement of the float 44 is strong.

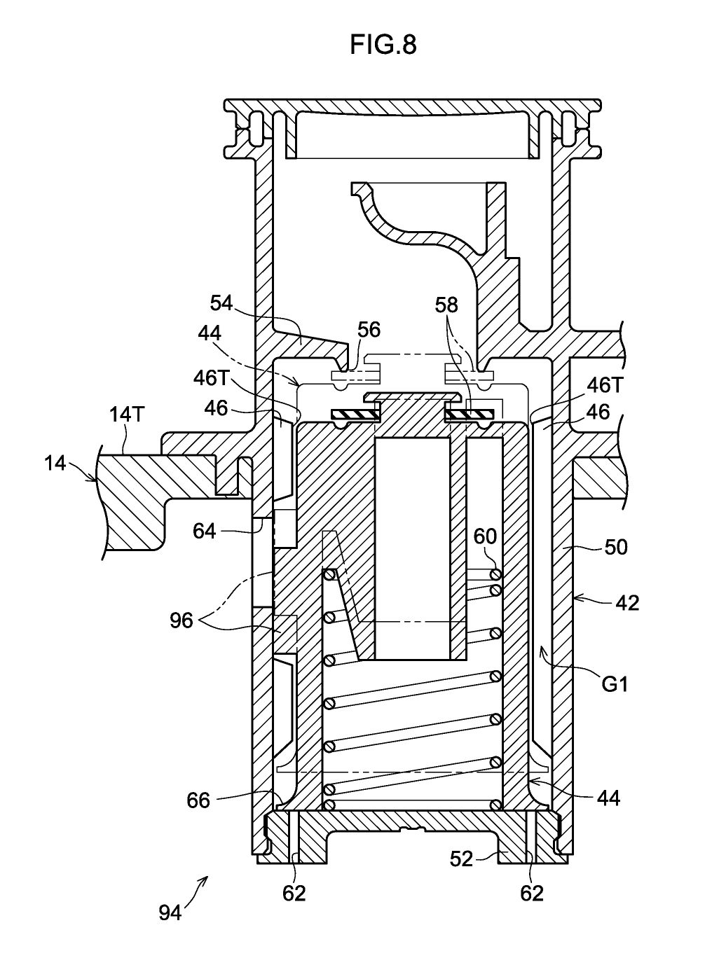

A third embodiment is described next. An ORVR valve 94 of the third embodiment is shown in FIG. 8. In the third embodiment, structural elements, members and the like that are the same as those of the first embodiment are denoted by the same reference numerals, and detailed description thereof is omitted. Further, in the third embodiment, the overall structure of the fuel tank structure is similar to that of the first embodiment, and therefore illustration thereof is omitted.

The ORVR valve 94 of the third embodiment has, as an example of the resistance member, a cover member 96 instead of the mesh member 68 of the first embodiment or the cover member 76 of the second embodiment.

The cover member 96 is formed as a convex portion at which the outer peripheral surface of the float 44 is projected-out locally toward the radial direction outer side. The shape and the position of the cover member 96 are set such that, when the float 44 is in the opening state, the cover member 96 opens a portion of the fuel inflow port 64 as shown by the solid line in FIG. 8, whereas, when the float 44 is in the blocking state, the cover member 96 covers the fuel inflow port 64 from the inner side as shown by the two-dot chain line in FIG. 8.

Also in the ORVR valve 94 of the third embodiment that has such a structure, in a case in which some of the pressure of the engine 28 acts on the ORVR valve 94, the resistance to vertical movement of the float 44 increases due to the dam member 66, and vertical movement of the float 44 is suppressed.

In the ORVR valve 94 of the third embodiment, when the float 44 is in the blocking state, the cover member 96 covers the fuel inflow port 64, and therefore, large movement resistance is applied as compared with a structure in which the fuel inflow port 64 is not covered. Because entering and exiting of the fuel, that is within the valve housing 42, through the fuel inflow port 64 is suppressed, the fuel that is within the valve housing 42 is effectively used as resistance to vertical movement of the float 44, and vertical movement of the float 44 can be suppressed. Note that, also in the third embodiment, when the float 44 is in the opening state, a portion of the fuel inflow port 64 is not covered by the cover member 96, and therefore, there is little effect on the entering and exiting of fuel into and from the valve housing 42.

Moreover, in the same way as in the ORVR valve 24 of the first embodiment, the fuel inflow port 64 is positioned further upward than the float buoyancy liquid level FL, and the opening cross-sectional areas of the flow-out holes 62 are made to be small. Therefore, it is easy to maintain the state in which fuel exists within the valve housing 42, and the effect of suppressing vertical movement of the float 44 is strong.

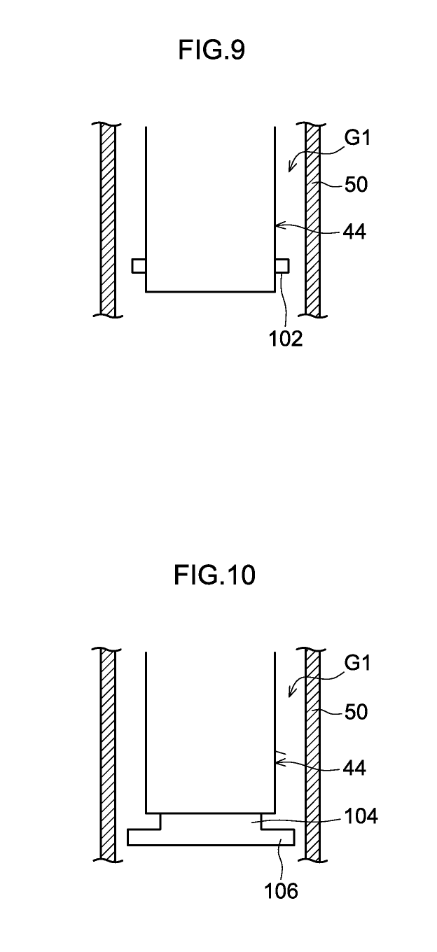

Embodiments of the present invention have been described above, but the dam member of the present invention is not limited to the above-described structure. In other words, it suffices to make the surface area in the direction of vertical movement of the float 44 large and to generate greater resistance to the vertical movement, by locally narrowing the gap between the float 44 and the valve housing 42. For example, as shown in FIG. 9, the dam member may be a dam member 102 that extends-out toward the radial direction outer side from an intermediate portion (a portion that is not the lower end) in the height direction at the float 44. Moreover, as shown in FIG. 10, a projecting member 104 may be made to project-out downward from the bottom portion of the float 44, and the dam member may be a dam member 106 that is structured so as to extend-out toward the radial direction outer side from this projecting member. If the projecting member 104 is formed in a solid cylindrical shape for example, the spring 60 (see FIG. 2) can be accommodated at the interior of the projecting member 104.

In the present application, even if pressure from the engine is applied to the float from the communication hole, vertical movement of the float can be suppressed.

The disclosure of Japanese Patent Application No. 2013-189476 that was filed on Sep. 12, 2013 is, in its entirety, incorporated by reference into the present specification.

All cited documents, patent applications and technical standards mentioned in the present specification are incorporated by reference in the present specification to the same extent as if the individual cited documents, patent applications and technical standards were specifically and individually incorporated by reference in the present specification.

What is claimed is:

1. A valve comprising:
a float that is provided within a fuel tank and that, by floating in fuel, blocks a communication hole that communicates with an engine;
a housing that accommodates the float within the fuel tank such that the float can move vertically, and into and from which fuel, that is within the fuel tank, enters and exits; and
a dam member that is provided at the float, and that locally narrows a gap between the float and the housing.

2. The valve of claim 1, further comprising:
a fuel inflow port that is formed in the housing and through which fuel, that flows into the housing, passes; and
a resistance member that, at least in a state in which the float blocks the communication hole, applies movement resistance to fuel that passes through the fuel inflow port.

3. The valve of claim 2, wherein the resistance member includes a mesh member that is provided at the fuel inflow port.

4. The valve of claim 2, wherein the resistance member includes a cover member that moves vertically together with the float and that, by rising, blocks at least a portion of the fuel inflow port.

5. The valve of claim 4, wherein the cover member is molded integrally with the float.

6. The valve of claim 5, wherein the cover member has:
a laterally extending portion that extends from the float and that passes through a through-hole of the housing;
an upwardly extending portion that extends upward from the laterally extending portion; and
a cover main body portion that is provided at the upwardly extending portion, and that covers the inflow port in a state in which the float blocks the communication hole.

7. The valve of claim 6, wherein, when the float rotates, the laterally extending portion contacts an inner surface of the through-hole and limits rotation of the float.

8. The valve of claim 2, wherein a lower end of the fuel inflow port is positioned further upward than a float buoyancy liquid level at which buoyancy of the fuel is applied to the float and causes the float to rise.

9. The valve of claim 1, wherein the dam member extends from an outer periphery of the float toward the housing.

10. The valve of claim 1, wherein the dam member is molded integrally with the float.

11. A fuel tank structure comprising:
a fuel tank that accommodates fuel; and
a valve having a float that is provided within the fuel tank and that, by floating in fuel, blocks a communication hole that communicates with an engine, a housing that accommodates the float within the fuel tank such that the float can move vertically, and into and from which fuel, that is within the fuel tank, enters and exits, and a dam member that is provided at the float, and that locally narrows a gap between the float and the housing.

12. The fuel tank structure of claim 11, further comprising:
a fuel inflow port that is formed in the housing and through which fuel, that flows into the housing, passes; and
a resistance member that, at least in a state in which the float blocks the communication hole, applies movement resistance to fuel that passes through the fuel inflow port.

13. The fuel tank structure of claim 12, wherein the resistance member includes a mesh member that is provided at the fuel inflow port.

14. The fuel tank structure of claim 12, wherein the resistance member includes a cover member that moves vertically together with the float and that, by rising, blocks at least a portion of the fuel inflow port.

15. The fuel tank structure of claim 14, wherein the cover member is molded integrally with the float.

16. The fuel tank structure of claim 15, wherein the cover member has:
a laterally extending portion that extends from the float and that passes through a through-hole of the housing;
an upwardly extending portion that extends upward from the laterally extending portion; and
a cover main body portion that is provided at the upwardly extending portion, and that covers the inflow port in a state in which the float blocks the communication hole.

17. The fuel tank structure of claim 16, wherein, when the float rotates, the laterally extending portion contacts an inner surface of the through-hole and limits rotation of the float.

18. The fuel tank structure of claim 12, wherein a lower end of the fuel inflow port is positioned further upward than a float buoyancy liquid level at which buoyancy of the fuel is applied to the float and causes the float to rise.

19. The fuel tank structure of claim 11, wherein the dam member extends from an outer periphery of the float toward the housing.

20. The fuel tank structure of claim 11, wherein the dam member is molded integrally with the float.
